(19) United States
(12) Patent Application Publication
(10) Pub. No.: US 2026/0035622 A1
(43) Pub. Date: Feb. 5, 2026

(54) INTEGRATED COMPRESSION AND STABILIZATION SYSTEM

(71) Applicant: SAUDI ARABIAN OIL COMPANY, Dhahran (SA)

(72) Inventors: Chidozie Eluwah, Dhahran (SA); Ekom Emmanuella Etuk, Abqaiq (SA)

(73) Assignee: SAUDI ARABIAN OIL COMPANY, Dhahran (SA)

(21) Appl. No.: 18/793,084

(22) Filed: Aug. 2, 2024

(51) Int. Cl. C10G 31/06; B01D 3/00; B01D 3/32

(52) U.S. Cl. CPC C10G 31/06; B01D 3/007; B01D 3/32

(57) ABSTRACT

A method for stabilizing whole crudes and condensate hydrocarbon mixtures. The method includes feeding a hydrocarbon mixture to a stabilizer column and separating the hydrocarbon mixture into an overhead offgas effluent and a stabilized hydrocarbon mixture; reboiling a stream from the stabilizer column with a heating medium, producing a reboiled stream; feeding the reboiled stream into the stabilizer column; heating a first side-stream from the stabilizer column with a stabilized hydrocarbon mixture from the stabilizer column, producing a heated first side-stream from the stabilizer column; and feeding the heated first side-stream into the stabilizer column.

### FIELD OF THE DISCLOSURE

Embodiments of the present disclosure generally relate to stabilizing whole crudes and condensate mixtures.

### BACKGROUND

Whole crudes and condensate mixtures will often contain lighter components, including but not limited to H₂S and CO₂ prior to being processed to meet target Reid Vapor Pressure (RVP) and True Vapor Pressure (TVP) of stabilized hydrocarbon liquid. Therefore, prior to processing, the whole crude and condensate mixture may be considered “unstabilized” and may be required to undergo stabilization to meet Reid Vapor Pressure and True Vapor Pressure requirements for downstream storage and processing. Conventionally, oil and gas operators utilize the addition of heat sources such as steam or heating oil to stabilize crude.

Typically, a vaporization is completed with a conventional stabilization system involving a stabilizer column, a feed preheater, a product pump, and a reboiler. The reboiler may utilizes a heating medium such as high-pressure steam, medium-pressure steam, low-pressure steam, or a heating oil. In addition to the use of a reboiler at the bottom of the stabilizer column, a side reboiler may be utilized, which may cross-exchange a cooler side-stream from the stabilizer column with the hotter stabilized crude and condensate stream from the stabilizer column. Typically, the heating medium utilized to heat the main reboiler is managed in a closed loop heating system requiring steam boilers, a cogeneration plant, and in some cases the operation of a facility by a third-party utility company. The operation of steam boilers, a cogeneration plant, and the engagement of a third-party utility company may impose high fixed costs, high variable costs, and a potentially compromised reliability.

### SUMMARY OF THE CLAIMED EMBODIMENTS

In one aspect, embodiments disclosed herein relate to a method for stabilizing whole crudes and condensate hydrocarbon mixtures. The method included feeding a hydrocarbon mixture to a stabilizer column and separating the hydrocarbon mixture into an overhead offgas effluent and a stabilized hydrocarbon mixture; reboiling a stream from the stabilizer column with a heating medium, producing a reboiled stream; feeding the reboiled stream into the stabilizer column; heating a first side-stream from the stabilizer column with a stabilized hydrocarbon mixture from the stabilizer column, producing a heated first side-stream from the stabilizer column; and feeding the heated first side-stream into the stabilizer column.

In another aspect, embodiments disclosed herein relate to a system for stabilizing whole crudes and condensate hydrocarbon mixtures. The system includes a stabilizer column for separating the hydrocarbon mixture into an overhead offgas effluent and a stabilized hydrocarbon mixture. The stabilizer column includes a feed inlet; a reboiler outlet; a reboiler inlet; one or more heat exchangers; a reboiler for reboiling a stream from the stabilizer column with a heating medium, producing a reboiled stream from the stabilizer column, and feeding the reboiled stream into the stabilizer column; and a product pump fluidly connected to a bottom of the stabilizer column; and wherein the one or more heat exchangers includes a first heat exchanger outlet receiving a first side-stream from the stabilizer column disposed at an elevation above the reboiler outlet of the stabilizer column and below the feed inlet; a first heat exchanger inlet receiving a heated first side-stream from the first heat exchanger disposed at an elevation below the first heat exchanger outlet of the stabilizer column; and a first heat exchanger for heating the first side-stream from the stabilizer column with the stabilized hydrocarbon mixture, producing the heated first side-stream from the stabilizer column, and feeding the heated first side stream into the stabilizer column.

Other aspects and advantages will be apparent from the following description and the appended claims.

### BRIEF DESCRIPTION OF DRAWINGS

FIG. 1 illustrates a process flow diagram of a system for stabilizing whole crudes and condensate hydrocarbon mixtures according to one or more embodiments disclosed herein.

FIG. 2 illustrates a process flow diagram of a system for stabilizing whole crudes and condensate hydrocarbon mixtures according to one or more embodiments disclosed herein.

FIG. 3 illustrates a method for stabilizing whole crudes and condensate hydrocarbon mixtures.

### DETAILED DESCRIPTION

Traditional reboiler heating mediums including steam and heating oil incur high variable and fixed costs to refineries and olefins facilities. These costs may be avoided by a combination of a reboilers utilizing waste heat, such as the excess heat from compressor discharge gas.

Whole crude and condensate mixtures useful in embodiments disclosed herein may include various hydrocarbon mixtures having a boiling point range, where the end boiling point of the mixture from between 5° and 250° C., such as a lower limit of 50, 75, 100, 125, 150, 175, 200 and 225 to an upper limit of 75, 100, 125, 150, 175, 200, 225, and 250, where any lower limit may be mathematically combined with any upper limit. In some embodiments, the end boiling point of the hydrocarbon mixtures may be a temperature greater than 250° C. The fraction of hydrocarbons in the hydrocarbon mixtures with a high boiling point, such as a boiling point over 250° C., may be from between 0.1 wt % and 5 wt %, 5 wt % and 10 wt %, 10 wt % and 20 wt %, 20 wt % and 30 wt %, 30 wt % and 40 wt %, and from between 40 wt % and 50 wt %. Processes described herein may be applied to whole crudes, condensates, and hydrocarbon mixtures. The hydrocarbon mixtures may include whole crudes, virgin crudes, hydroprocessed crudes, wide boiling range napthas to gas oil condensates, diesels, kerosenes, gasolines, synthetic napthas, hydrocracker wax, Fischer-Tropsch wax, Fischer-Tropsch liquids, Fischer-Tropsch gases, gas oils, vacuum gas oils, heating oils, jet fuels, raffinate reformates, natural gasolines, distillates, virgin napthas, natural gas condensates, atmospheric pipestill bottoms, vacuum pipestill streams including bottoms, heavy non-virgin hydrocarbon streams from refineries, vacuum gas oils, heavy gas oils, and atmospheric residuum, among others.

Embodiments disclosed herein involve processes for stabilizing whole crudes and condensate hydrocarbon mixtures. The process includes feeding a hydrocarbon mixture to a stabilizer column and separating the hydrocarbon mixture into an overhead offgas effluent and a stabilized hydrocarbon mixture; reboiling a stream from the stabilizer column with a heating medium, producing a reboiled stream from the stabilizer column; and feeding the reboiled stream into the stabilizer column.

The process may include feeding a hydrocarbon mixture to a stabilizer column operating at a pressure of greater than 60 psig and separating the hydrocarbon mixture into an overhead offgas effluent and a stabilized hydrocarbon mixture. The hydrocarbon mixture may be fed near a top of the stabilizer column and may trickle down the trays to a bottom of the stabilizer column where the hydrocarbon mixture may be contacted with a hotter stabilized hydrocarbon mixture.

The contact between the cooler hydrocarbon mixture feed and the hotter stabilized hydrocarbon mixture may cause a vapor phase overhead offgas effluent to form and collect at the top of the stabilizer column. Meanwhile, the hotter liquid phase stabilized hydrocarbon mixture may collect at the bottom and may be pumped out of the stabilizer column by a product pump. The stabilized hydrocarbon mixture product may then be pressurized to a pressure greater than the stabilizer column pressure of greater than 60 psig. Such pressures may overcome any head requirements to reach any downstream crude tanks or collection points.

The overhead offgas effluent may include light components including H₂S and CO₂. The stabilized hydrocarbon mixture may meet a target Reid Vapor Pressure (RVP) of 14 kPa absolute (2 psia) to 83 kPa absolute (12 psia). Additionally, the stabilized hydrocarbon mixture may meet a maximum True Vapor Pressure (TVP) not exceeding 90 kPa absolute (13 psia) at maximum operating temperature in the export pipeline or maximum crude storage temperature, at a target maximum operating temperature of 60° C.

The overhead offgas effluent may then be processed downstream in a compressor, dryer, or processing plant. The liquid phase stabilized hydrocarbon mixture may be pumped out of the stabilizer column with a product pump, cooled in a first heat exchanger that may be a cross-exchanger utilizing a first side-stream drawn from the stabilizer, and collected downstream.

The process may include reboiling a stream from the stabilizer column with a heating medium. The reboiler may utilize a heating medium including compressor discharge gas. The compressor discharge gas may have a pressure from between 400 and 1200 psig, such as a lower limit of 400, 500, 600, 700, 800, 900, 1000, and 1100 psig, to an upper limit of 500, 600, 700, 800, 900, 1000, 1100, and 1200 psig, where any lower limit can be combined with any mathematically compatible upper limit. The compressor discharge gas may have a temperature from between 120 and 230° C., such as a lower limit of 120, 130, 140, 150, 160, 170, 180, 190, 200, 210, and 220° C., to an upper limit of 130, 140, 150, 160, 170, 180, 190, 200, 210, 220, and 230° C., where any lower limit can be combined with any mathematically compatible upper limit. The compressor discharge gas may be from one or more compressors from any downstream equipment, gas plant, refinery operation, olefins operation, any associated process located outside OSBL, in combinations thereof. Furthermore, as a result of cooling the compressor discharge gas in the reboiler, the compressor discharge gas may be efficiently cooled to a temperature which allows reducing or removing downstream heat exchange requirements in any compressor after-coolers.

After the stream has been heated in the bottoms reboiler, a reboiled stream from the stabilizer column may be collected and fed back into the stabilizer column. The reboiled bottoms stream may be in a vapor phase and may flow up to the stabilizer column by the driving force of pressure differential. Once the reboiled stream reaches the stabilizer column, the stabilized hydrocarbon mixture will flow to the bottom of the stabilizer column and the lighter components will flow to the top of the stabilizer column as overhead offgas effluent.

In one or more embodiments, the process includes heating a first side-stream from the stabilizer column, which may be received and heated in a first heat exchanger. The first side-stream may be heated to a temperature of between 7° and 140° C., such as a lower limit of 70, 80, 90, 100, 110, 120, and 130° C., to an upper limit of 80, 90, 100, 110, 120, 130, and 140° C., where any lower limit can be combined with any mathematically compatible upper limit.

In one or more embodiments, the first heat exchanger may be a cross-exchanger utilizing the stabilized hydrocarbon mixture from the bottom of the stabilizer column to heat the first side-stream. The stabilized hydrocarbon mixture may be cooled while the first side-stream may be heated, thereby reducing the heat input required in the reboiler.

In one or more embodiments, a second side-stream from the stabilizer column may be received and heated in a second heat exchanger. In one or more embodiments, the second side-stream may be heated in the second heat exchanger with a heating medium including hot compressor discharge gas, steam, or a heating oil. The second side-stream may be heated to a temperature of between 13° and 170° C., such as a lower limit of 130, 135, 140, 145, 150, 155, 160, and 165° C., to an upper limit of 135, 140, 145, 150, 155, 160, 165 and 170° C., where any lower limit can be combined with any mathematically compatible upper limit.

Embodiments disclosed herein include a system for stabilizing whole crudes and condensate hydrocarbon mixtures, including a stabilizer column, one or more heat exchangers, and a reboiler.

In one or more embodiments, stabilizer column may be rated for a pressure of greater than 60 psig. The stabilizer column may include a feed inlet disposed proximate a top of the stabilizer column. The stabilizer column may be equipped with trays or packing. The stabilizer column may be equipped with trays between 10 and 50 trays, such as a lower limit of 10, 15, 20, 25, 30, 35, 40, and 45 trays, to an upper limit of 15, 20, 25, 30, 35, 40, 45, and 50 trays, where any lower limit can be combined with any mathematically compatible upper limit. The stabilizer column may be equipped with bubble cap trays, sieve trays, dual flow trays, valve trays, and baffle trays. In another embodiment, the stabilizer column may have packing which may include random or structured packing. In one or more embodiments, the stabilizer column may include one or more chimney trays. The chimney tray may be employed to collect liquid which may be recirculated back into the stabilizer column as reflux, separate liquid phase from the vapor phase, and provide liquid hold-up.

The stabilizer column length may be from between 20 and 120 ft, such as a lower limit of 20, 30, 40, 50, 60, 70, 80, 90, and 100 ft, to an upper limit of 30, 40, 50, 60, 70, 80, 90, 100, and 120 ft, where any lower limit can be combined with any mathematically compatible upper limit. The stabilizer column may have a diameter of from between 6 and 25 ft, such as a lower limit of 6, 10, 15, 20, and 25 ft, to an upper limit of 10, 15, 20, 20 and 25 ft, where any lower limit can be combined with any mathematically compatible upper limit.

The stabilized hydrocarbon mixture may be collected at the bottom of the stabilizer column and removed by a product pump fluidly connected to the bottom of the stabilizer column. The product pump may be a positive displacement pump, a centrifugal pump, or a rotary pump. Alternatively, the product pump may include a spare pump to allow for increased reliability and redundancy during any pump maintenance downtime. The stabilized hydrocarbon mixture may be pumped to a pressure not exceeding the pressure rating of the pipe or the downstream pressure relief valve set point on the piping. Additionally, the pressure must be high enough to overcome the head required to reach downstream tanks and collection points. The product pump may pressurize the stabilized hydrocarbon mixture to enable flow through the hot side of a first heat exchanger while the first side-stream from the stabilizer column flows through the cold side.

The system may include a reboiler. The reboiler may receive a stream from the stabilizer column, which may be collected from a reboiler stream outlet disposed proximate the bottom of the stabilizer column. In one or more embodiments, the reboiler may be a Once Through Thermosiphon type or a Circulating Thermosiphon type. The Once Through Thermosiphon type may allow for reduction in the vapor loading to the bottom tray, thus allowing a reduction in the diameter of the stabilizer column and the likelihood of flooding. In one or more embodiments, the reboiler may indirectly heat the stream with a heating medium including but not limited to a compressor discharge gas. In other embodiments, the reboiler may indirectly heat the stream with a heating medium including a steam stream or a heating oil stream. The stream may be removed from the stabilizer column at a reboiler outlet proximate the bottom of the stabilizer column. The stabilizer column may receive the reboiled stream at a reboiler inlet disposed at an elevation above the bottom of the stabilizer column and below the reboiler outlet. In one or more embodiments, the reboiler outlet may be fluidly connected to a chimney tray. In one or more embodiments, the reboiled stream may be in the form of a vapor, liquid, or combinations thereof.

The system may include a first heat exchanger which may receive a first-side stream from the stabilizer column. The first heat exchanger may receive the first side-stream from the stabilizer column from a first heat exchanger outlet disposed below the feed inlet and above the reboiler outlet. In one or more embodiments, the first heat exchanger outlet may be fluidly connected to a chimney tray. In one or more embodiments, the first heat exchanger may indirectly heat the first side-stream with the stabilized hydrocarbon mixture. The stabilizer column may receive the heated first side-stream at a first heat exchanger inlet disposed at an elevation below the first heat exchanger outlet of the stabilizer column and above the reboiler outlet.

The system may include a second heat exchanger which may receive a second-side stream from the stabilizer column. The second heat exchanger may receive the second side-stream from the stabilizer column from a second heat exchanger outlet disposed below the first heat exchanger inlet and above the reboiler outlet. In some embodiments, the second heat exchanger outlet may be fluidly connected to a chimney tray. In one or more embodiments, the second heat exchanger may indirectly heat the second side-stream with a heating medium including but not limited to a compressor discharge gas, a steam stream, or a heating oil. The stabilizer column may receive the heated second side-stream stream at a second heat exchanger inlet disposed at an elevation below the second heat exchanger outlet of the stabilizer column and above the reboiler outlet.

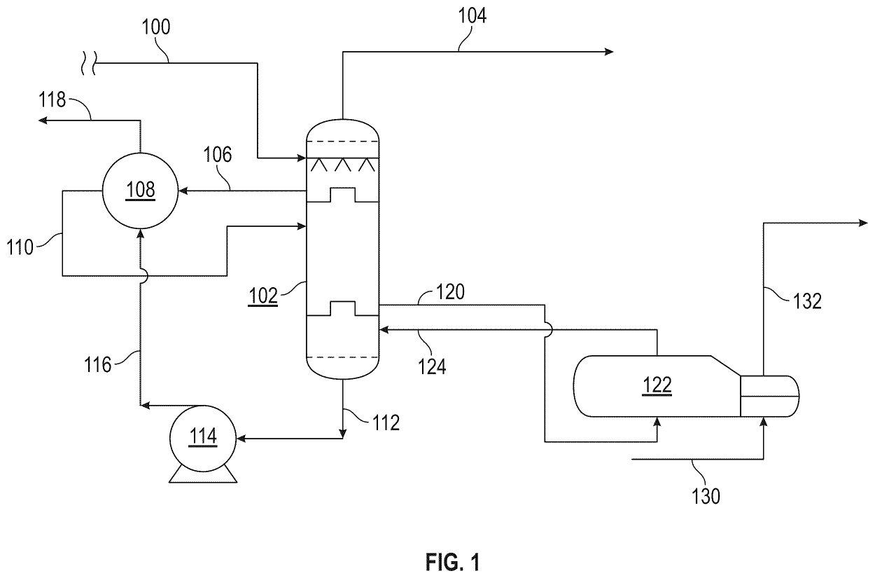

Turning now to FIG. 1, a simplified process flow diagram of a system for stabilizing whole crudes and condensate hydrocarbon mixtures, according to embodiments disclosed herein is illustrated. A hydrocarbon mixture 100 is fed into a stabilizer column 102 at a feed inlet disposed a top of the stabilizer column 102 operated at a pressure of greater than 60 psig.

In one or more embodiments, the stabilizer column 102 is fluidly connected to a reboiler 122 through a reboiler outlet and stream 120, which is reboiled into a reboiled stream 124 to a temperature between 120 and 230° C. in some embodiments, or from 160 and 220° C. in other embodiments, by a heating medium 130, which may include a compressor discharge gas. The compressor discharge gas is cooled by the reboiler 122 into cooled compressor discharge gas 132, which may allow for the reduction or elimination of the use of the compressor after-coolers. Additionally, the use of compressor discharge gas from any one of an onsite associated downstream equipment, gas plant, refinery or olefins operation may reduce variable and fixed costs by reducing the need for the compressor after-coolers, a steam stream, or a heating oil. While not shown, the heating medium 130 may in some embodiments include a heating oil or a steam stream, and thus after being cooled in the reboiler 122, the heating medium 130 may become cooled heating medium 132, including a cooled heating oil stream or a cooled steam stream.

The reboiler 122 and the trays on the stabilizer column 102 enable the separation of the hydrocarbon mixture into an overhead offgas effluent 104 and a stabilized hydrocarbon mixture 112. The stabilized hydrocarbon mixture 112 may then be pumped out of the stabilizer column 102 by a product pump 114 and may become a pressurized stabilized hydrocarbon mixture 116.

In one or more embodiments, a first side-stream 106 may flow from a first heat exchanger outlet disposed at an elevation above the reboiler outlet of the stabilizer column 102 and below the feed inlet, into a first heat exchanger 108 to be heated by heating medium to a temperature between 70 and 140° C. The heating medium may include a pressurized stabilized hydrocarbon mixture 116. The pressurized stabilized hydrocarbon mixture 116 may be flowed into the first heat exchanger 108, which operated as a cross exchanger, may cool the pressurized stabilized hydrocarbon mixture 116 into cooled stabilized hydrocarbon mixture 118, and simultaneously heat the first side-stream 106 into a heated first side-stream 110. The heated first side-stream 110 is then recirculated into the stabilizer column 102 at a first heat exchanger inlet disposed below the heat exchanger outlet. Although not shown in the figure, the cooled stabilized hydrocarbon mixture 118 may be collected further downstream in tanks or removed from the facility.

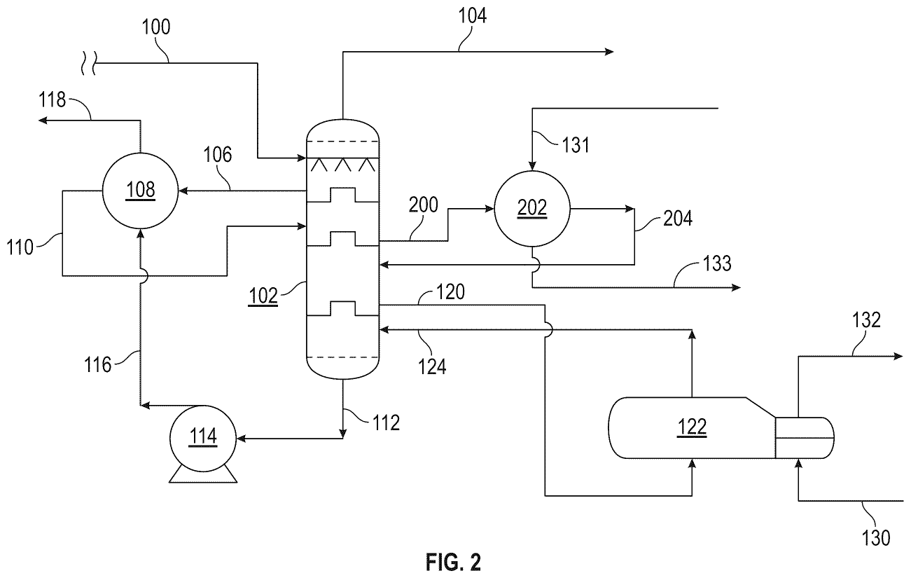

Turning now to FIG. 2, a simplified process flow diagram of a system for stabilizing whole crudes and condensate hydrocarbon mixtures, according to embodiments disclosed herein is illustrated, where like numerals represent like parts. Similar to the process scheme illustrated in FIG. 1, described above, the system as illustrated in FIG. 2 includes a stabilizer column, a first heat exchanger, and a reboiler, and a second heat exchanger. The second heat exchanger 202 receives the second side-stream 200 from a second heat exchanger outlet disposed above the reboiler outlet and below the first heat exchanger inlet of the stabilizer column 102. The second side-stream 200 flows into the second heat exchanger 202 and is heated to a temperature between 130 and 170° C. by a heating medium 131 into a heated second side-stream 204. The heated second side-stream 204 then flows from the second heat exchanger 202 into a second heat exchanger inlet disposed below the second heat exchanger outlet of the stabilizer column 102. The heating medium 131 utilized for the second heat exchanger 202 may, like the heating medium 130 for the reboiler 122, be a compressor discharge gas, a steam stream, or a heating oil. The heating medium 131 is cooled by the second heat exchanger 202 into a cooled heating medium 133, including cooled compressor discharge gas, a cooled steam stream, or a cooled heating oil.

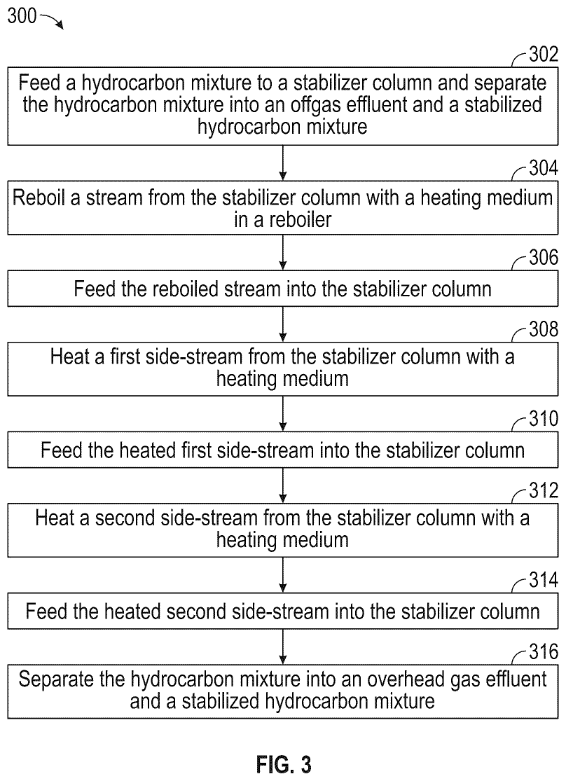

Turning now to FIG. 3, a method for stabilizing whole crudes and condensate mixtures 300, according to embodiments disclosed herein is illustrated. At step 302, a hydrocarbon mixture is fed into a feed inlet, proximate a top a stabilizer column that is operated at a pressure of greater than 60 psig. The hydrocarbon mixture passes through trays in the stabilizer column while heat is added to the column and undergoes separation into an offgas effluent and a stabilized hydrocarbon mixture. For example, at step 304, heat is added to a stream flowing from a reboiler outlet proximate the bottom of the stabilizer column into a reboiler that is receiving heating medium to heat the stream into a reboiled stream. At step 306, the reboiled stream may then be received by the stabilizer column at the reboiler inlet disposed below the reboiler outlet on the stabilizer column.

In addition to adding heat to the stabilizer column via the reboiler, there may be a first heat exchanger that adds heat to the stabilizer column. The first heat exchanger may receive a first side-stream from the first heat exchanger outlet of the stabilizer column disposed above the reboiler outlet of the stabilizer column and below a feed inlet. At step 308, the first side-stream is heated into a heated first side-stream by a first heat exchanger. The heated first side-stream is fed back into the stabilizer column at the first heat exchanger inlet disposed below the first heat exchanger outlet of the stabilizer column at step 310.

In addition to adding heat to the stabilizer column via the reboiler and the first heat exchanger, there may be a second heat exchanger that receives a second side-stream from the second heat exchanger outlet of the stabilizer column disposed above the reboiler outlet of the stabilizer column and below the first heat exchanger inlet. At step 312 the second side-stream is heated into a heated second side-stream by a second heat exchanger. The heated second side-stream is fed back into the stabilizer column at the second heat exchanger inlet disposed below the second heat exchanger outlet of the stabilizer column at step 314. Finally, all of the heat addition provided by the reboiler, the first heat exchanger, and the second heat exchanger may provide the energy required to separate the hydrocarbon mixture into an overhead gas effluent and stabilized hydrocarbon mixture at step 316. This step, although described last, is concurrent with all the preceding steps in the method for stabilizing whole crudes and condensate mixtures 300.

Embodiments disclosed herein relate to processes and systems of separating whole crudes and condensate mixtures into an overhead gas effluent and a stabilized hydrocarbon mixture. The processes and systems may reduce the need for conventional heating mediums such as steam and heating oil by utilizing the waste heat of compressor discharge gas. This may provide the additional benefit of reducing compressor after-coolers. Any reduction of required equipment and heating medium may contribute to lowering fixed and variable costs associated with stabilizing whole crudes and condensate mixtures.

Finally, it is to be understood that the configurations described above, along with the specific examples and uses are only illustrations of the application of the principles in the present invention. Numerous modifications and variants of the arrangements may be made by those skilled in the art without departing from the spirit and scope of the present disclosure and the appended claims are intended to include such modifications. Thus, while the present invention has been described above with particularity, it will be apparent to those of ordinary skill in the art that numerous modifications, including but not limited to, variations in assembly, size, materials, form, function, and operation may be used without departing from the principles and concepts set forth herein.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

Ranges may be expressed as from about one particular value to about another particular value, inclusive. When such a range is expressed, it is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed is:

1. A method for stabilizing whole crudes and condensate hydrocarbon mixtures, the method comprising:
feeding a hydrocarbon mixture to a stabilizer column and separating the hydrocarbon mixture into an overhead offgas effluent and a stabilized hydrocarbon mixture;
reboiling a stream from the stabilizer column with a heating medium, producing a reboiled stream;
feeding the reboiled stream into the stabilizer column;
heating a first side-stream from the stabilizer column with a stabilized hydrocarbon mixture from the stabilizer column, producing a heated first side-stream from the stabilizer column; and
feeding the heated first side-stream into the stabilizer column.

2. The method of claim 1, further comprising:
heating a second side-stream from the stabilizer column with the heating medium, producing a reboiled second side-stream from the stabilizer column; and
feeding the reboiled second side-stream into the stabilizer column.

3. The method of claim 1, wherein the heating medium includes a compressor discharge gas, a steam stream, or a heating oil stream.

4. The method of claim 2, wherein the heating medium includes a compressor discharge gas, a steam stream, or a heating oil stream.

5. The method of claim 1, wherein the separating a hydrocarbon mixture occurs at a pressure of greater than 60 psig.

6. A system for stabilizing whole crudes and condensate hydrocarbon mixtures, the system comprising:
a stabilizer column for separating the hydrocarbon mixture into an overhead offgas effluent and a stabilized hydrocarbon mixture, a stabilizer column comprising:
a feed inlet;
a reboiler outlet; and
a reboiler inlet;
one or more heat exchangers;
a reboiler for reboiling a stream from the stabilizer column with a heating medium, producing a reboiled stream from the stabilizer column, and feeding the reboiled stream into the stabilizer column; and
a product pump fluidly connected to a bottom of the stabilizer column;
wherein the one or more heat exchangers comprises:
a first heat exchanger outlet receiving a first side-stream from the stabilizer column disposed at an elevation above the reboiler outlet and below the feed inlet;
a first heat exchanger inlet receiving a heated first side-stream from the first heat exchanger disposed at an elevation below the first heat exchanger outlet of the stabilizer column; and
a first heat exchanger for heating the first side-stream from the stabilizer column with the stabilized hydrocarbon mixture, producing the heated first side-stream from the stabilizer column, and feeding the heated first side-stream into the stabilizer column.

7. The system of claim 6, wherein the one or more heat exchangers further comprises:
a second heat exchanger outlet receiving a second side-stream from the second heat exchanger disposed at an elevation above the reboiler outlet and below the first heat exchanger inlet;
a second heat exchanger inlet receiving a heated second side-stream from the second heat exchanger disposed at an elevation below the second heat exchanger outlet of the stabilizer column; and
a second heat exchanger for heating the second side-stream from the stabilizer column with a heating medium, producing the heated second side-stream from the stabilizer column, and feeding the heated second side-stream into the stabilizer column.

8. The system of claim 6, wherein the reboiling a stream from the stabilizer column with a heating medium includes heating medium comprising compressor discharge gas, a steam stream, or a heating oil stream.

9. The system of claim 7, wherein the heating the second side-stream with heating medium includes a heating medium comprising compressor discharge gas, a steam stream, or a heating oil stream.

10. The system of claim 6, wherein the reboiler outlet receiving the stream from the stabilizer column is disposed proximate the bottom of the stabilizer column.

11. The system of claim 6, wherein the reboiler stream inlet receiving the reboiled stream from the reboiler is disposed at an elevation above the bottom of the stabilizer column and below the reboiler outlet.

12. The system of claim 7, wherein the feed inlet is disposed proximate a top of the stabilizer column.

13. The system of claim 7, wherein the stabilizer column is operated at a pressure of greater than 60 psig.
